(19) United States
(12) Patent Application Publication
(10) Pub. No.: US 2022/0111849 A1
(43) Pub. Date: Apr. 14, 2022

(54) DETERMINING DRIVING FEATURES USING TIMED NARROW AI AGENT ALLOCATION

(71) Applicant: AUTOBRAINS TECHNOLOGIES LTD, Tel Aviv (IL)

(72) Inventors: Igal Raichelgauz, Tel Aviv (IL); Adam Harel, Tel Aviv (IL); Roi Saida, Acco (IL)

(73) Assignee: AUTOBRAINS TECHNOLOGIES LTD, Tel Aviv (IL)

(21) Appl. No.: 17/445,311

(22) Filed: Aug. 17, 2021

Related U.S. Application Data
(60) Provisional application No. 63/066,750, filed on Aug. 17, 2020.

(51) Int. Cl. B60W 30/18; B60W 40/04; B60W 60/00; G06N 3/04

(52) U.S. Cl. CPC B60W 30/18163; B60W 40/04; G06V 20/58; G06N 3/04; B60W 60/001

(57) ABSTRACT

A method for determining driving related features of a vehicle, the method may include: repeating, during each time interval out of multiple time intervals of a period; obtaining sensed information during at least a part of the time interval; receiving context information determined before the time interval; selecting, based on the context information, a selected sub-set of narrow artificial intelligence (AI) agents or calculating one or more driving related features. The calculating may include applying the selected sub-set of narrow AI agents on the sensed information; and determining, based on the sensed information, context information to used following the time interval.

### BACKGROUND

Classical production advance driver assistance system (ADAS) systems are usually rigid in their implementation, and are produced under strict compute resources limitations.

These two factors yield a system that excels at compromising—averaging the qualities of its sub features, reaching the point of minimal acceptable quality at the predefined compute limit.

There is a growing need to provide more accurate ADAS systems.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a timing diagram;

FIG. 3 illustrates an example of a method;

FIG. 4 illustrates an example of a timing diagram;

FIG. 5 illustrates an example of a system;

FIG. 6 illustrates an example of method;

FIGS. 7-8 illustrate examples of a timing diagram; and

FIG. 9 illustrates an example of a system.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided

The specification and/or drawings may refer to an image. An image is an example of a media unit. Any reference to an image may be applied mutatis mutandis to a media unit. A media unit may be an example of sensed information unit. Any reference to a media unit may be applied mutatis mutandis to sensed information. The sensed information may be sensed by any type of sensors—such as a visual light camera, or a sensor that may sense infrared, radar imagery, ultrasound, electro-optics, radiography, LIDAR (light detection and ranging), etc

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The analysis of content of a media unit may be executed by generating a signature of the media unit and by comparing the signature to reference signatures. The reference signatures may be arranged in one or more concept structures or may be arranged in any other manner. The signatures may be used for object detection or for any other use.

The signature may be generated by creating a multidimensional representation of the media unit. The multidimensional representation of the media unit may have a very large number of dimensions. The high number of dimensions may guarantee that the multidimensional representation of different media units that include different objects is sparse—and that object identifiers of different objects are distant from each other—thus improving the robustness of the signatures.

The generation of the signature is executed in an iterative manner that includes multiple iterations, each iteration may include an expansion operations that is followed by a merge operation. The expansion operation of an iteration is performed by spanning elements of that iteration.

A driving related feature may include, for example an object detection feature (for example an identification of an object, a location of an object, a movement pattern of an object) a predictive feature related to a road user (estimated future movement pattern), an autonomous driving feature that may determine a manner in which an autonomous vehicle is driven (control of acceleration, deceleration, speed limit, and the like), an ADAS feature that may affect a suggestion to a driver or may include a feature of a partial autonomous driving (for example may affect a lace correction process, and the like.

A narrow AI agent may include an entire neural network, or may include only a part of a neural network. Different AI agents may share one or more layers.

A narrow AI agent may be preceded by one or more layers of one or more networks.

A narrow AI agent may include one or more layers or one of more neural networks.

A narrow AI agent may be followed by one or more layers of one or more neural networks.

A narrow AI agent is narrow in the sense that it is (or it belongs to a neural network) not trained to respond to all possible (or all probable, or a majority of) scenarios that should be dealt by a vehicle—but only for some of the scenarios.

For example—each AI narrow agent may be trained (or may belong to a neural network that was trained) to respond to a fraction (for example less than 1 percent) of these scenarios and/or may be trained to respond to only some factors or elements or parameters or variables that form a scenario.

The narrow AI agents may be of the same complexity and/or of same parameters (depth, energy consumption, technology implementation)—but at least some of the narrow AI agents may differ from each other.

The narrow AI agents (or the neural networks that include the narrow AI agents) may be trained in a supervised and/or non-supervised manner.

There may be provides a method that acquires, per each time interval, sensed information associated with the time interval and applies at least a selected sub-set of one or more narrow AI agents associated with the time interval.

The selected sub-set may be determined in advance and/or may be determined in a dynamic manner—for example per context.

The AI agents of the sub-set may be selected based on the ADAS function—object detection (OD) for example of pedestrians and vehicles, lane detection (LD), sign detection (SR), traffic light detection (TLR)—or any other ADAS function.

The AI agents of the sub-set may be selected based on a main purpose of the method. Assuming that there is a certain complexity and/or latency and/or cost limitation—different tradeoffs may be provided between at least some of detectable types of objects, allowable size of objects to be detected by the method and/or the field of view—the pixels that should be processed out of the image.

For example—the following table illustrates four different examples of configurations—that differ from each by their main purpose. The depth of field (for example 0-50 meters, 0-25 meters, 0-100 meters) determine the minimal and maximal size of objects that should be detected by the method (for example the number of pixels in the images that may represent a pedestrian located within a range of 0-50 meters from the camera). The FOV determines the area within the images that should be taken into account—while other pixels are ignored of. The type of features (all features or certain features) indicate which objects should be detected by the method.

The following table provides different tradeoffs for different main purposes.

The first row illustrates a configuration that its main purpose is to perform object detection of certain objects—and thus may not limit the field of view of the distance.

The second row illustrates a configuration that its main purpose is to operate quickly- and allow a high frame rate (high Frame Per Second)—and thus is not limited to the type of object but may impose limits on the distance range and FOV. For example—a larger distance range of 50-150 is applied on the center of the image only (center FOV).

The third row illustrates a configuration that its main purpose is to operate on an extra wide FOV—and either limits (in the first till third time interval) the type of detected objects and the distance range, or limits (in the fourth interval) the FOV.

The fourth row illustrates a configuration that its main purpose is to cover a large distance range—and either limits (in the first till third time interval) the type of detected objects, or limits (in the fourth interval) the distance range.

The different configurations may use different narrow AI agents trained under different constraints.

The table assumes that there are four time intervals. This is merely an example.

| System | First time | Second time | Third time | Fourth time |
|---|---|---|---|---|
| priority | interval | interval | interval | interval |
| Object- | OD - | Sign- | OD - | Traffic-Lights |
| Detection | Pedestrians, | Recognition, Lane- | Pedestrians, | (TLR), |
| (OD) | Cars, two | Detection | Cars, two | Free-Space |
| | wheelers | (SR + LD) | wheelers | |
| High-FPS | All-Features | All-Features | All-Features | All-Features |
| | 0-50 meters, | 0-25 meters, | 0-50 meters, | 50-150 meters, |
| | Wide FOV | Extra-Wide FOV | Wide FOV | Center FOV |
| Extra-wide | OD - | LD - | SR, TLR | All-Features |
| FOV | 0-50 meters | 0-50 meters | 0-50 meters | 50-150 meters |
| | Extra-Wide FOV | Extra-Wide FOV | Extra-Wide FOV | Center FOV |
| Long Range | OD - | LD - | SR, TLR - | All-Features |
| | 0-100 meters, | 0-100 meters | 0-100 meters | 0-20 meters |
| | Wide FOV | Wide FOV | Wide FOV | Extra-Wide FOV |

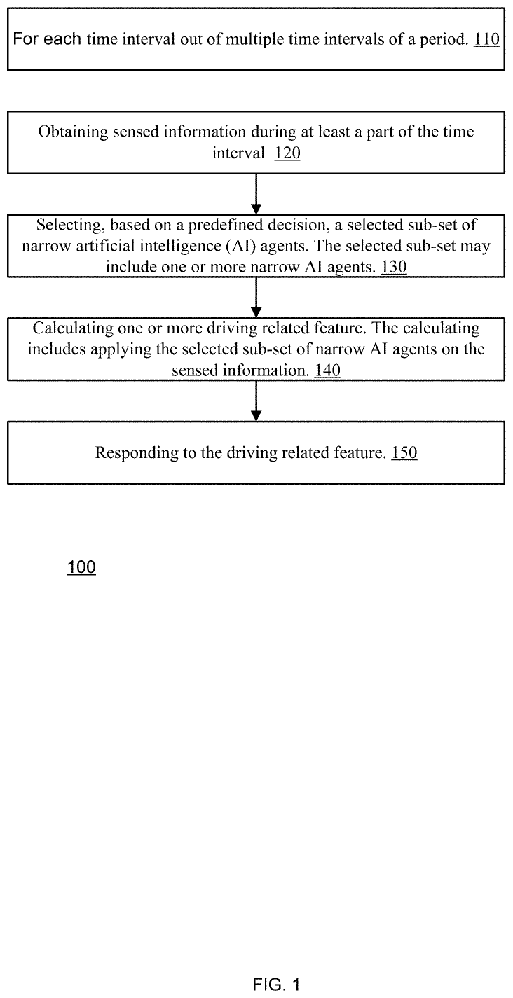

FIG. 1 illustrates an example of method 100.

Method 100 may be for determining driving related features of a vehicle.

Method 100 may include dividing a period into time intervals (Step 110).

During each time interval:
a. Obtaining sensed information during at least a part of the time interval (Step 120).
b. Selecting, based on a predefined decision, a selected sub-set of narrow artificial intelligence (AI) agents (Step 130). The selected sub-set may include one or more narrow AI agents. When the sub-set includes multiple narrow AI agents then the multiple narrow AI agents may be connected in any manner—serial, parallel, partially serial and/or partially parallel, and the like.
c. Calculating one or more driving related feature (Step 140). The calculating may include applying the selected sub-set of narrow AI agents on the sensed information.

The period (may range between a few seconds to a few hours—and even more) may include multiple repetitions of a sub-period (For example assuming that the table above “cover” a sub-period of two hundred milliseconds—then a driving session that may last between a few minutes to a few hours may include multiple repetitions of two hundred milliseconds.

Each sub-period may include N time intervals, N being a positive integer that exceeds one.

Method 100 may include repeating the selection set for the sub-period over the entire driving session (or over a part of a driving session).

The repetition may include applying an n'th sub-set of narrow AI agents during an n'th time intervals of different sub-periods, n ranges between 1 and N. For example—assuming that there are four time intervals per sub-period than the same selection of narrow AI agents is made for the first time interval of each sub-periods, the same selection of narrow AI agents is made for the second time interval of each sub-periods, and the like.

Referring to the first row of the table—
a. The most frequently selected sub-set of narrow AI agents may include one or more narrow AI agents allocated for detection of road users selected out of vehicles and pedestrians.
b. A less frequently selected sub-set of narrow AI agents comprises a narrow AI agent allocated for lane detection.
c. A less frequently selected sub-set of narrow AI agents comprises a narrow AI agent allocated for traffic light detection.

It should be noted that the driving related feature may be outputted from a narrow AI agent. Alternatively—the output of the AI agent may be an intermediate results that should be further processed to provide the driving related feature.

Step 140 may be followed by step 150 of responding to the driving related feature.

The responding may include autonomously driving the vehicle based on the at least one driving related feature.

The responding may include performing an advance driver assistance system (ADAS) operation based on the at least one driving related feature.

Step 130 and/or step 140 may be responsive to at least one parameter out of a field of view associated with the time interval, a certain range of detection associated with the time interval, and/or a rate that is associated with the time interval.

Examples of selection based on the on these parameters are shown in the table.

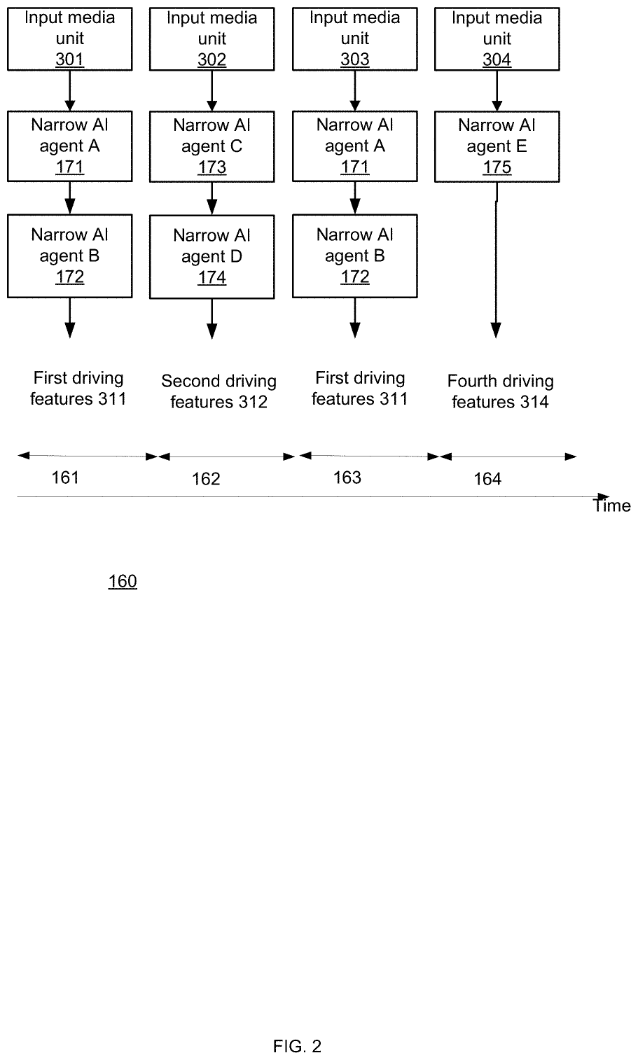

FIG. 2 illustrates a timing diagram 160 that shows four time intervals 161, 162, 163 and 164 and the processing executed during the four time intervals of a sub-period.

It is assumed that the timing diagram illustrates the execution of the first row of the table:

| First time | Second time | Third time | Fourth time |
|---|---|---|---|
| interval 161 | interval 162 | interval 163 | interval 164 |
| Main purpose - | Main purpose - | Main purpose - | Main purpose - |
| detect | Sign-Recognition, | detect Pedestrians, | detects Traffic- |
| Pedestrians, Cars, | Lane-Detection | Cars, two wheelers | Lights (TLR), |
| two wheelers | (SR + LD) | | Free-Space |
| A combination of | A combination of | A combination of | Selected narrow |
| selected narrow | selected narrow AI | selected narrow AI | AI agent E 175 - |
| AI agents A 171 | agents C 173 and D | agents A 171 and | detects Traffic- |
| and B 172 - the | 174 - the | B 172 - the | Lights (TLR), |
| combination detects | combination | combination detects | Free-Space |
| Pedestrians, Cars, | performs SR + LD | Pedestrians, Cars, | |
| two wheelers | | two wheelers | |

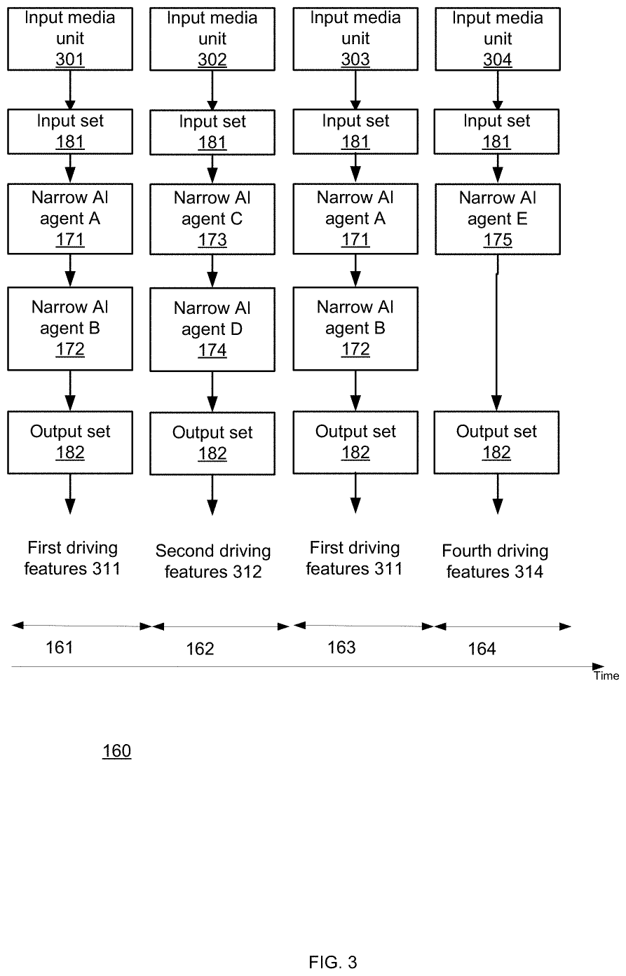

FIG. 3 illustrates a timing diagram in which the narrow AI agents are preceded by an input set 181 of layers of a neural network, and are followed by output set 182 of layers of a neural network.

In this case the narrow AI agents, the input set 181 and the output set 182 form a complete neural network. The input set 181 may be shared by the different neural networks that include any of the narrow AI agents—so that the input set 181 may be re-used—and the narrow AI agents may include intermediate layers of a neural network.

The same applied to the output set 182—they may be shared by the different neural networks that include any of the narrow AI agents.

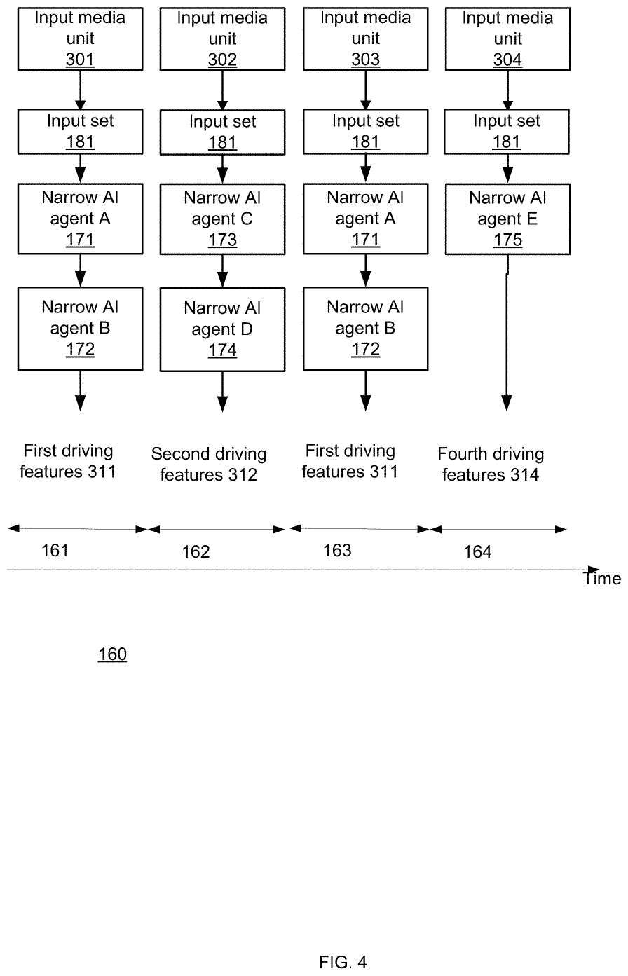

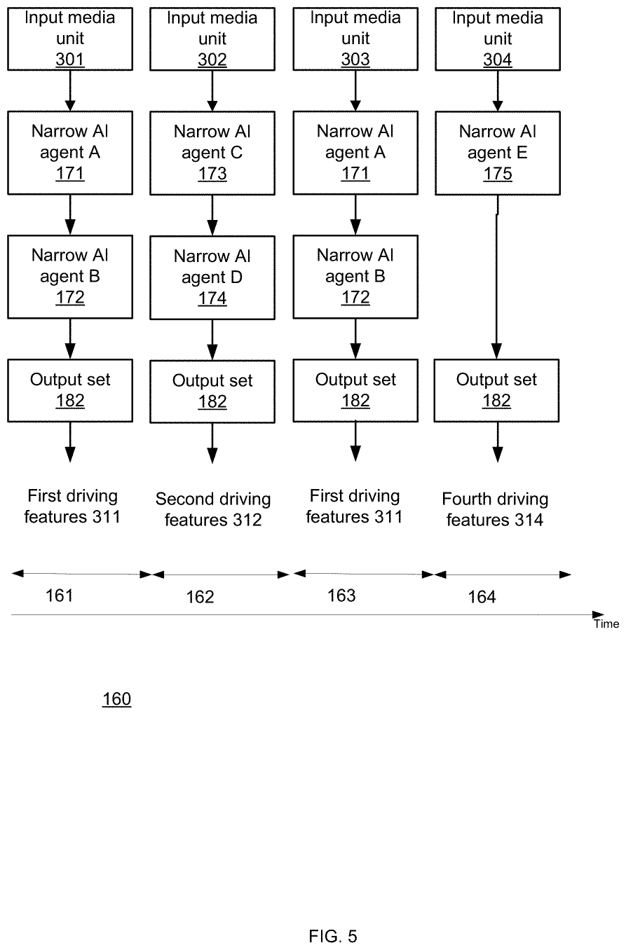

It should be noted that only the input set 181 may be provided (see FIG. 4), only the output set 182 may be provided (see FIG. 5), both may be provided or not.

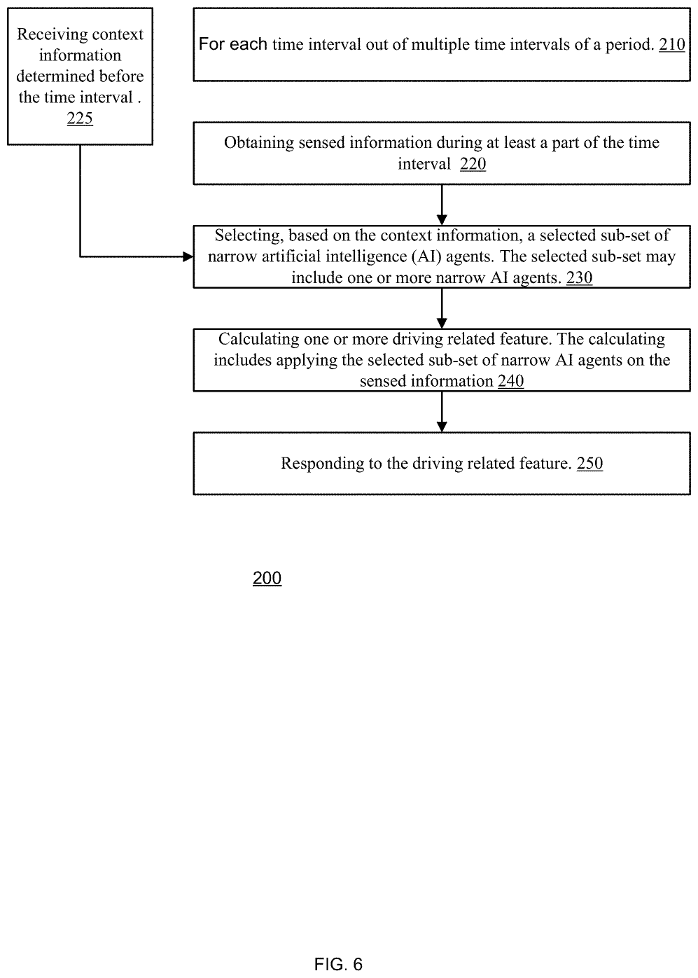

FIG. 6 illustrates an example of method 200.

Method 200 may be for determining driving related features of a vehicle.

Method 200 may include dividing a period into time intervals (Step 210).

During each time interval:
a. Obtaining sensed information during at least a part of the time interval (Step 220).
b. Receiving context information determined before the time interval (step 225).
c. Selecting, based on the context information, a selected sub-set of narrow artificial intelligence (AI) agents (step 230).
d. Calculating one or more driving related features, wherein the calculating comprises applying the selected sub-set of narrow AI agents on the sensed information (Step 240).
e. Determining, based on the sensed information, context information to used following the time interval (Step 250).
f. Responding to the one or more driving related features (Step 255).

The context may include at least one of (a) an object that appears in the sensed information, (b) a driving maneuver to be applied by the vehicle, and (b) at least one sensed information acquisition related feature.

The at least one sensed information acquisition related feature may be related to illumination conditions—for example the overall intensity of illumination, night illumination, day illumination, fog, rain and the like.

The driving maneuver may be an overtaking maneuver or any other driving maneuver.

The object may be a road object such as a junction, a roundabout, a zebra crossing, a highway, and the like.

The sub-set may consist of a single narrow AI agent—or may include two or more narrow AI agents.

Step 255 may include autonomously driving the vehicle based on the at least one driving related feature.

Step 255 may include performing an advance driver assistance system (ADAS) operation based on the at least one driving related feature.

It should be noted that the driving related feature may be outputted from a narrow AI agent. Alternatively—the output of the AI agent may be an intermediate results that should be further processed to provide the driving related feature.

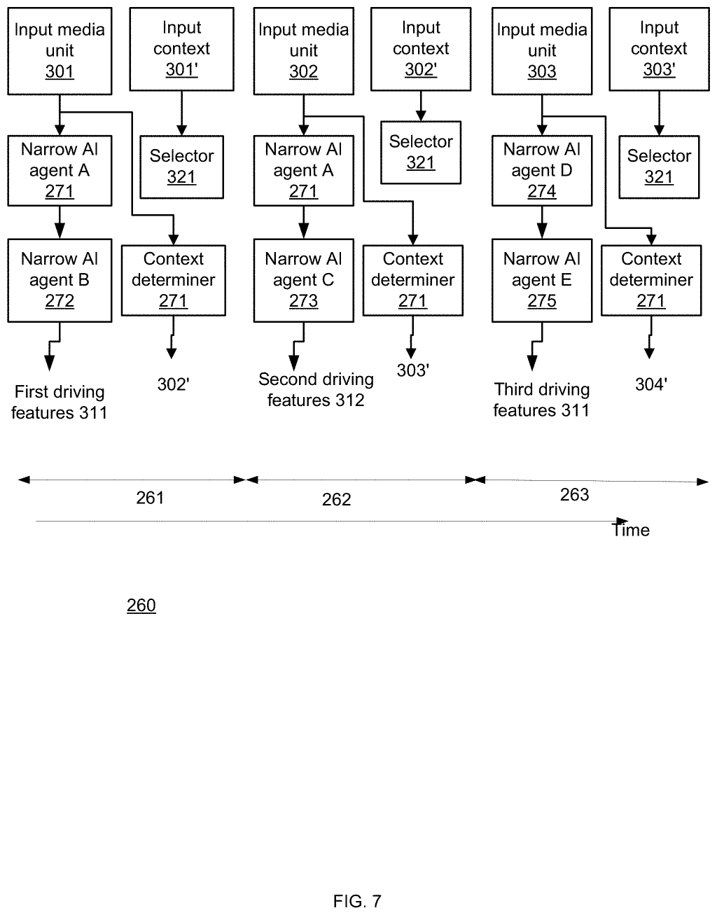

FIG. 7 illustrates a timing diagram 260 that shows three time intervals 161, 162 and 163 and the processing executed during the three time intervals.

| First time | Second time | Third time |
|---|---|---|
| interval 261 | interval 262 | interval 263 |
| Input context - DAY, | Input context - DAY, | Input context - NIGHT, |
| HIGHWAY | OVERTAKE | EXIT |
| A combination of | A combination of selected | A combination of |
| selected narrow AI | narrow AI agents A 271 and | selected narrow AI |
| agents A 271 and B 272 - | C 273 - - the combination | agents D 274 and E 275 - - |
| the combination detects | detects objects that are | the combination detects |
| objects that are expected | expected to appear in a | objects that are expected |
| to appear in a context of | context of a OVERTAKE | to appear in a context of |
| a HIGHWAY and the DAY | that occurs during the DAY | an EXIT and the DAY |
| Output context - DAY, | Output context - NIGHT, | Output content - |
| OVERTAKE | EXIT | ROUNDABOUT |

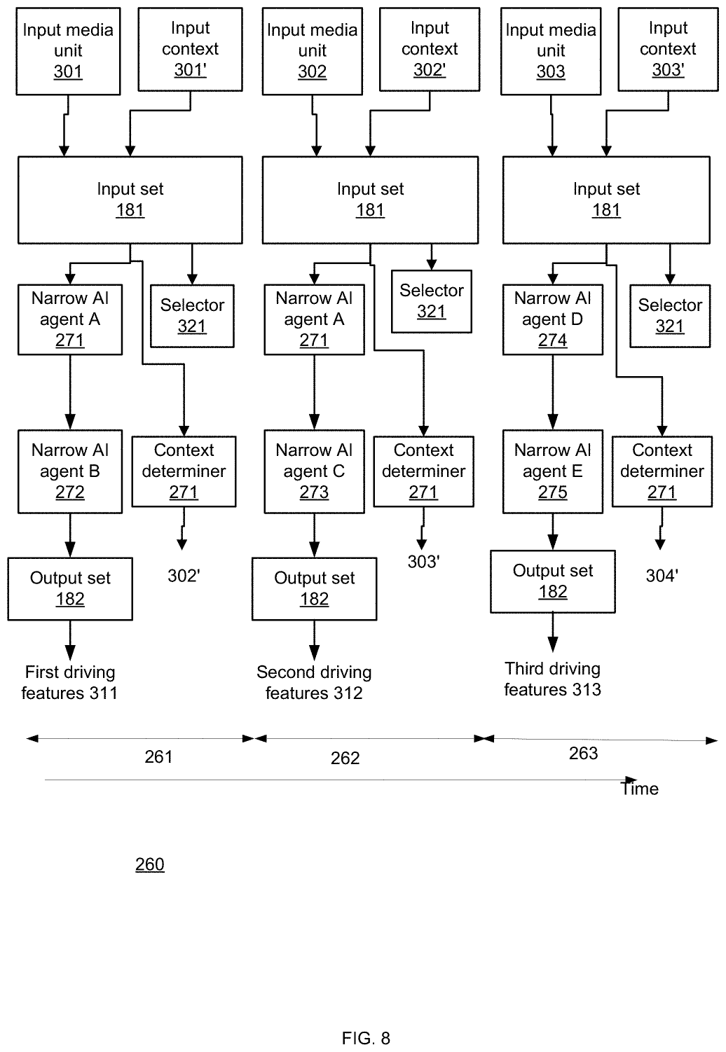

FIG. 8 illustrates a timing diagram in which the narrow AI agents are preceded by an input set 181 of layers of a neural network, and are followed by output set 182 of layers of a neural network.

In this case the narrow AI agents, the input set 181 and the output set 182 form a complete neural network. The input set 181 may be shared by the different neural networks that include any of the narrow AI agents—so that the input set 181 may be re-used—and the narrow AI agents may include intermediate layers of a neural network.

The same applied to the output set 182—they may be shared by the different neural networks that include any of the narrow AI agents.

It should be noted that only the input set 181 may be provided, only the output set 182 may be provided, both may be provided or not.

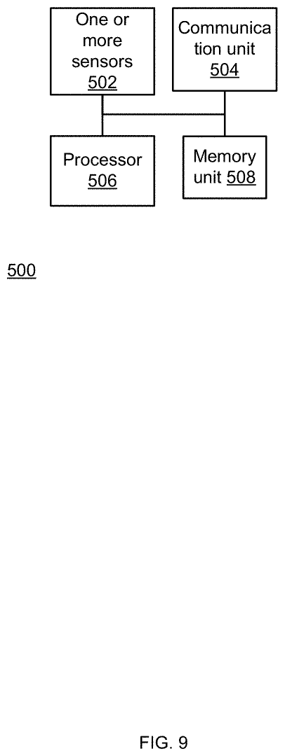

FIG. 9 illustrates an example of a system 500 capable of executing one or more of the mentioned above methods.

The system include various components, elements and/or units.

A component element and/or unit (such as but not limited to a processor) may be a processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Alternatively, each component element and/or unit may implemented in hardware, firmware, or software that may be executed by a processing circuitry.

System 500 may include one or more sensors 502, communication unit 504, processor 506, and memory unit 508. It should be noted that the system 500 may not include the one or more sensors and in this case the communication unit 504 may be configured to obtain sensed information.

The system 500 may be part of an autonomous driving unit, may be configured to provide driving related features to an autonomous driving unit, may be configured to provide outputs that are further processed to provide driving related features to an autonomous driving unit, may be part of an ADAS unit, may be configured to provide driving related features to an ADAS unit, may be configured to provide outputs that are further processed to provide driving related features to an ADAS unit, and the like.

The processor 506 may be a hardware neural network processor or may be configured to perform neural network processing in any other manner.

The communication unit may be or may include any suitable communications component such as a network interface card, universal serial bus (USB) port, disk reader, modem or transceiver that may be operative to use protocols such as are known in the art to communicate either directly, or indirectly, with other elements of the system.

The communication unit may communicate with other units of the vehicle such as a vehicle computer, brakes, acceleration unit, man machine interface, and the like.

Additionally or alternatively, the communication unit may communicate with devices and/or units that are not a part of the vehicle—such as a mobile phone of a driver, a remote computerized unit, another vehicle, and the like.

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub combination. It will be appreciated by persons skilled in the art that the embodiments of the disclosure are not limited by what has been particularly shown and described hereinabove. Rather the scope of the embodiments of the disclosure is defined by the appended claims and equivalents thereof.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for determining driving related features of a vehicle, the method comprises:
repeating, during each time interval out of multiple time intervals of a period:
obtaining sensed information during at least a part of the time interval;
receiving context information determined before the time interval;
selecting, based on the context information, a selected sub-set of narrow artificial intelligence (AI) agents;
calculating one or more driving related features, wherein the calculating comprises applying the selected sub-set of narrow AI agents on the sensed information; and
determining, based on the sensed information, context information to used following the time interval.

2. The method according to claim 1 wherein the context comprises at least one of (a) an object that appears in the sensed information, (b) a driving maneuver to be applied by the vehicle, and (b) at least one sensed information acquisition related feature.

3. The method according to claim 2 wherein the at least one sensed information acquisition related feature is related to illumination conditions.

4. The method according to claim 2 wherein the driving maneuver is an overtaking maneuver.

5. The method according to claim 2 wherein the object is selected out of a junction, and a roundabout.

6. The method according to claim 1 wherein the sub-set consists of a single narrow AI agent.

7. The method according to claim 1 wherein the sub-set comprises two or more narrow AI agents.

8. The method according to claim 1 wherein the applying the selected sub-set of narrow AI agents on the sensed information provides at least one narrow AI output; and wherein the calculating further comprises processing the at least one narrow AI output to provide the one or more driving related feature.

9. The method according to claim 1 comprising autonomously driving the vehicle based on the at least one driving related feature.

10. The method according to claim 1 comprising performing an advance driver assistance system (ADAS) operation based on the at least one driving related feature.

11. The method according to claim 1 wherein at least one narrow AI agent of the selected sub-set of narrow AI agents is a part of a neural network.

12. The method according to claim 2 wherein at least one other narrow AI agent of the selected sub-set of narrow AI agents is another part of the neural network.

13. A non-transitory computer readable medium that stores instructions for.
